(19) United States
(12) Patent Application Publication
(10) Pub. No.: US 2025/0137807 A1
(43) Pub. Date: May 1, 2025

(54) CURATION OF MAP DATA FOR CHANGED ROADWAY FEATURES

(71) Applicant: TOYOTA JIDOSHA KABUSHIKI KAISHA, TOYOTA-SHI (JP)

(72) Inventors: HADI FADAIFARD, Palo Alto, CA (US); PAT SALEMBIER, Palo Alto, CA (US); IOANNIS STAMOS, Palo Alto, CA (US); ARIEL KADOURI, Brooklyn, NY (US); HUONG QUYNH DINH, Palo Alto, CA (US); LINDSEY MIRELES, Palo Alto, CA (US); ALANA OHNO, Palo Alto, CA (US)

(21) Appl. No.: 18/497,959

(22) Filed: Oct. 30, 2023

(51) Int. Cl. G01C 21/00; G01C 21/32

(52) U.S. Cl. CPC G01C 21/3807; G01C 21/32; G01C 21/3844

(57) ABSTRACT

In some aspects, systems and methods may detect an unmapped feature at a determined position along a vehicle's trajectory based on sensor data from one or more vehicle sensors. The systems and methods may scan sensor data from the vehicle sensors along the trajectory of the vehicle to identify sensor data representing an existing map feature on a map. Furthermore, the systems and methods may determine a vehicle-centric position of the existing map feature based on the sensor data, compare the determined vehicle-centric position of the existing map feature to a map-based position of the existing map feature and determine a transformation based on the vehicle-centric position of the existing map feature and the map-based position of the existing map feature. Moreover, systems and methods may apply the transformation to the determined position of the unmapped feature to obtain a refined position of the unmapped feature.

### TECHNICAL FIELD

The present disclosure relates generally to feature mapping, and in particular, some implementations may relate to systems and methods for updating map data based on vehicle sensor data.

### DESCRIPTION OF RELATED ART

Autonomous vehicle technology is becoming more commonplace with the introduction of new vehicles each model year. While widespread adoption of fully autonomous vehicles is only now becoming visible on the horizon, autonomous vehicle technology is gaining increasing popularity for assisted driving and other semi-autonomous vehicle operation.

Map data plays an important role in enabling Autonomous Vehicles (AVs) to navigate safely and efficiently. These maps are often referred to as High-Definition (HD) maps or Autonomous Vehicle Maps (AVMs). HD and other resolution maps may include detailed geospatial information about the environment, such as the location of road features including lanes, intersections, traffic signs, signals, curbs, and other roadside features. Lane markings, curbs and other like data can provide lane-level information, to identify where a road is as well as where the lanes are and their exact dimensions. The maps may include the location of and information about traffic signals, stop signs, yield signs, and other road signs.

Maps may be augmented with high-resolution imagery, including images from cameras mounted on AVs or other sources. This visual data can help AVs recognize landmarks, navigate through complex areas, and verify the environment. Some maps are three-dimensional, providing detailed information about the height and shape of objects in the environment.

Maps, however, need to be updated to reflect changes in the environment, such as new road construction, changes in traffic patterns, new or moved features (e.g., lane markings, road signs, etc.) and temporary road closures.

### BRIEF SUMMARY OF THE DISCLOSURE

Various embodiments of the disclosed technology relate to systems and methods for curating map data. Some aspects may relate to using information obtained from vehicle sensors to detect new map features such as, for example, new lane markings, road signs, traffic signals, and so on. Systems and methods disclosed herein may be configured to detect an unmapped feature at a determined position along a vehicle's trajectory using sensor data from one or more vehicle sensors. This information may be used to determine the feature type and its position (e.g., position along a roadway). To refine the new object's position, the systems and methods may be configured to identify data representing one or more existing, already mapped features along the vehicle's trajectory and to compare the position of those features as determined using data from the vehicle sensors with the position of those objects as noted in the map.

This comparison may provide information to refine the positions and orientations (poses) of the vehicle along the trajectory in the map. The refined and well-localized vehicle poses can be used to identify the map-centric position(s) of the new object(s) (based on vehicle data). Furthermore, the system can be used to determine if the positions, size, or orientations of an existing, mapped, feature has been modified based on vehicle data. In such scenarios, the system will compute the updated, map-centric, position, size, and orientation of the feature and update the map accordingly. Moreover, the system may use the vehicle data to determine if an existing, mapped, feature is removed; the system will update the map accordingly.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include detecting at least one change in a first feature at a determined position along the trajectory of the vehicle based on sensor data from one or more sensors of the vehicle. The method may also include scanning sensor data from the one or more sensors of the vehicle along the trajectory of the vehicle to identify sensor data representing one or more existing map features on a map. The method may furthermore include determining a vehicle-centric position of the one or more existing map features based on the sensor data from one or more sensors of the vehicle. The method may in addition include comparing the determined vehicle-centric position of the one or more existing map features to a map-based position of their corresponding one or more existing map features and determining a difference between the vehicle-centric positions of the one or more existing map features and corresponding map-based positions of the one or more existing map features. The method may moreover include determining a transformation based on the determined difference and applying the transformation to the vehicle-centric position of the first feature to obtain a revised position of the first feature. Other embodiments of this aspect include corresponding computer systems, apparatus, and computer programs recorded on one or more computer storage devices, each configured to perform the actions of the methods.

Implementations may include one or more of the following features. The method where applying the transformation aligns positions of the vehicle along the trajectory and the vehicle-centric positions of the one or more existing features with the map. The method where applying the transformation to the determined position of the first feature obtain a revised position of the first feature may include applying the transformation to the determined vehicle-centric position of the first feature to obtain a revised position of the first feature in the map. The method, where applying the transformation to the vehicle-centric position of the first feature to obtain a revised position of the first feature may include determining, based on sensor data, whether at least one of a position, orientation, or size of the first feature has changed, and upon detecting a change in at least one of a position, orientation, and size of the first feature, applying the transformation to the vehicle-centric position of the first feature to obtain at least one of a revised position, orientation, and size of the first feature. The method may include updating at least one of the position, orientation and size of the first feature on the map to reflect the change. The method, where determining a transformation, may include determining a position offset between the vehicle-centric position of the one or more existing map features and the map-based position of the one or more existing map features. The method may include comparing the first feature to existing features on the map to determine if the first feature is a new feature. The method may include updating the map to include the new feature at the revised position. The method may include comparing a set of one or more vehicle-centric features to existing features on the map to determine if the first feature has been removed from along the trajectory and upon detection of removal of the feature, updating the map to reflect removal of the feature. The method may include updating the map to remove the first feature from the map. The method, where the first feature may include at least one of a road sign and lane markings. Implementations of the described techniques may include hardware, a method or process, or a computer tangible medium.

In one general aspect, a system may include one or more processors configured to perform operations of: detecting at least one change in a first feature at a determined position along the trajectory of the vehicle based on sensor data from one or more sensors of the vehicle; scanning sensor data from the one or more sensors of the vehicle along the trajectory of the vehicle to identify sensor data representing one or more existing map features on a map; determining a vehicle-centric position of the one or more existing map features based on the sensor data from one or more sensors of the vehicle; comparing the determined vehicle-centric position of the one or more existing map features to a map-based position of their corresponding one or more existing map features and determining a difference between the vehicle-centric positions of the one or more existing map features and corresponding map-based positions of the one or more existing map features. The system may also include determining a transformation based on the determined difference and applying the transformation to the vehicle-centric position of the first feature to obtain a revised position of the first feature. Other embodiments of this aspect include corresponding computer systems, apparatus, and computer programs recorded on one or more computer storage devices, each configured to perform the actions of the methods.

Implementations may include one or more of the following features. The system where applying the transformation aligns positions of the vehicle along the trajectory and the vehicle-centric positions of the one or more existing map features with the map. The system where applying the transformation to the determined position of the first feature obtain a revised position of the first feature may include applying the transformation to the determined vehicle-centric position of the first feature to obtain a refined position of the first feature in the map. The system where applying the transformation to the vehicle-centric position of the first feature to obtain a revised position of the first feature may include determining, based on sensor data, whether at least one of a position, orientation, or size of the first feature has changed, and upon detecting a change in at least one of a position, orientation, and size of the first feature, applying the transformation to the vehicle-centric position of the first feature to obtain at least one of a revised position, orientation, and size of the first feature. The system may include updating at least one of the position, orientation and size of the first feature on the map to reflect the change. The system where determining a transformation, may include determining a position offset between the vehicle-centric position of the one or more existing map features and the map-based position of the one or more existing map features. The system where the one or more processors are further configured to perform the operation of comparing the first feature to existing features on the map to determine if the first feature is a new feature. The system where the one or more processors are further configured to perform the operation of updating the map to include the new feature at the revised position. The system where the one or more processors are further configured to perform the operation of comparing a set of one or more vehicle-centric features to existing features on the map to determine if the first feature has been removed from along the trajectory and upon detection of removal of the first feature, updating the map to reflect removal of the first feature. The system where the one or more processors are further configured to perform the operation of updating the map to remove the first feature from the map. The system where the first feature may include at least one of a road sign and lane markings. Implementations of the described techniques may include hardware, a method or process, or a computer tangible medium.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a flowchart illustrating an example process for curating new map information in accordance with various aspects of the systems and methods disclosed herein.

FIG. 2 illustrates an example dashboard that may be presented to a system user in accordance with various aspects of the systems and methods disclosed herein.

FIG. 3 illustrates an example of identifying existing map features in accordance with various aspects of the systems and methods disclosed herein.

FIG. 4 is a flowchart of an example process for using additional existing objects to refine a changed object's position data in accordance with various aspects of the systems and methods disclosed herein.

FIG. 5 illustrates an example of a user interface for updating attribute values for an object in accordance with various aspects of the systems and methods disclosed herein.

FIG. 6 illustrates an example of a dashboard that includes windows for entering/updating object parameters (e.g., attribute values), and for updating the object information to the map in accordance with various aspects of the systems and methods disclosed herein.

FIG. 7 is an example computing component that may be used to implement various features of the systems and methods described in the present disclosure.

The figures are not exhaustive and do not limit the present disclosure to the precise form disclosed.

### DETAILED DESCRIPTION

Aspects of the systems and methods disclosed herein relate to using information obtained from vehicle sensors to detect new, moved, removed or otherwise changed map features such as, for example, lane markings, road signs, traffic signals, and so on. Aspects of the technology disclosed herein may be configured to detect unmapped features along a vehicle's trajectory using sensor data from one or more vehicle sensors. Systems and methods may use this information to determine characteristics such as the feature type, its position along a roadway, and other characteristics (e.g., text on a road sign, color of lane markings, and so on).

Because the object's position as determined by the sensor data may be less accurate than is desired for the map (which may include a high-definition, medium-definition, standard-definition or other resolution map), aspects of the systems and methods disclosed herein may be configured to update or refine the object's position. This can be done, for example, by comparing the position of one or more other, known, roadway features detected by the vehicle sensors with their respective positions as cataloged on the map to determine if there is an error or offset between position information determined based on vehicle sensor data and position information as indicated on the map (which may be assumed for this purpose to be more accurate).

Particularly, aspects of the technology disclosed herein may be configured to identify data representing an existing, already mapped feature along the vehicle's trajectory and its vehicle-centric position as determined from vehicle sensor data. That determined vehicle-centric data can be compared to a map-based position of that feature. This comparison may be used to determine a transformation based on a position offset between the vehicle-centric position of the existing map feature and the map-based position of the feature as noted on the map. The systems and methods may apply this same offset to revise the noted position of the new feature. This can be used to adjust or account for inaccuracies or imprecision in position determination based on vehicle sensor data.

Information about the vehicle-centric features available to the system from the sensors may be 2D or 3D data. 2D data may arise, for example, in situations where the vehicle sensors that obtained the features were cameras (as opposed to, e.g., lidar). In such cases, the system may use the refined or unrefined vehicle poses along the trajectory to compute the 3D positions, orientations, and sizes of the vehicle-centric features.

In some applications, a transformation may be determined for existing map features can be weighted when it is applied to offset or adjust the determined position of new features. Weightings can be set, for example, based on factors such as, for example, bearing to the respective feature, distance between the vehicle and the respective feature, distance between the existing feature and the new feature, and so on.

The systems and methods disclosed herein may be implemented using sensor data from any of a number of different autonomous or semi-autonomous vehicles and vehicle types. Data may even be gathered from sensors on non-autonomous vehicles. For example, the systems and methods disclosed herein may be used with cars, trucks, buses, construction vehicles and other on- and off-road vehicles. These can include vehicles for transportation of people/personnel, materials or other items. In addition, the technology disclosed herein may also extend to other vehicle types as well.

Vehicle sensors used to gather data may include a plurality of different sensors to gather data regarding the vehicle and its surrounding environment. For example, sensors may include lidar, radar, infrared sensors, image sensors and other data gathering sensors. GPS or other vehicle positioning systems may be used to gather data regarding a position of the vehicle at a given time, which may be used in conjunction with sensor data to calculate a vehicle-centric feature position.

Distance measuring sensors such as lidar, radar, infrared sensors and other like sensors can be used to gather data to measure distances and closing rates to various external roadway features such as traffic signs, light poles, curbs, lane markings, and other objects. Image sensors can include one or more cameras or other image sensors to capture images of the environment around the vehicle including objects along the vehicle trajectory. Information from image sensors can be used to determine information about the environment surrounding the vehicle including, for example, information regarding objects surrounding the vehicle. For example, image sensors may be able to recognize features or other objects (including, e.g., street signs, traffic lights, lane markings, curbs, etc.), slope of the road, objects to be avoided (e.g., other vehicles, pedestrians, bicyclists, etc.) and other objects. Information from the image sensors can be used in conjunction with other information such as map data or information from positioning system to determine, refine or verify information about objects along the vehicle's trajectory including object type, vehicle-centric object position, object characteristics (e.g., text on a road sign), and so on.

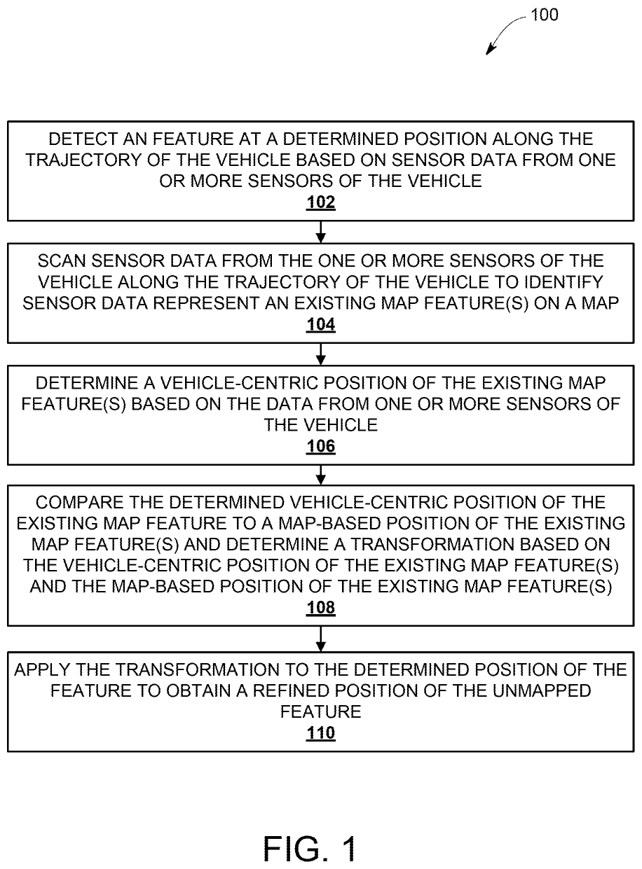

FIG. 1 is a flowchart illustrating an example process for curating new map information in accordance with various aspects of the systems and methods disclosed herein. As shown in the example of FIG. 1, at operation 102 process 100 detects a feature at a determined position along the trajectory. For example, sensor data from one or more vehicle sensors may be evaluated to identify the presence of objects along the vehicle's trajectory. When an object is detected (or its absence detected), it can be compared to existing objects on a map to determine whether the detected object is a new object (not already mapped), an existing map object that has already been mapped or a mapped object that has been removed from the real world. In some implementations, an object that has been moved physically from one location to another and that is detected at the new location may be deemed a new or unmapped feature. Accordingly, implementations may detect an unmapped feature at a determined position along the trajectory of the vehicle based on sensor data from one or more sensors of the vehicle, as described above.

A vehicle-centric position for new objects can be determined using vehicle sensor data. For example, range and bearing from the vehicle to the object can be computed using vehicle sensor data. This range and bearing can be used along with vehicle position data (e.g., from the vehicle's GPS or other position determination system) to calculate the vehicle-centric position. However, this vehicle-centric position may not be as accurate as desired due to imprecision or inaccuracies in the vehicle sensor data. For example, GPS accuracy can suffer from predicted-orbit errors, clock errors, atmospheric errors, interference and so on. Similarly, LIDAR, while generally very accurate, may suffer from atmospheric conditions, interference, or other error-inducing conditions. Therefore, as described below, it may be desirable to refine the vehicle-centric position determined for the new object.

As also shown in the example of FIG. 1, at operation 104, process 100 may scan sensor data from the one or more sensors of the vehicle along the trajectory of the vehicle to identify sensor data representing an existing map feature on a map. For example, the system may receive sensor data from the one or more sensors of the vehicle along the trajectory and use the data to identify or display another object along the roadway. This object can be compared to objects already mapped to determine whether it is an existing map feature.

As further shown in FIG. 1, operation 106 of example process 100 may include determining a vehicle-centric position of an existing map feature based on the data from one or more sensors of the vehicle. For example, GPS data can be used to determine the vehicle position and sensor data (e.g. range and bearing) can be used to compute a vehicle-centric object position from the vehicle position.

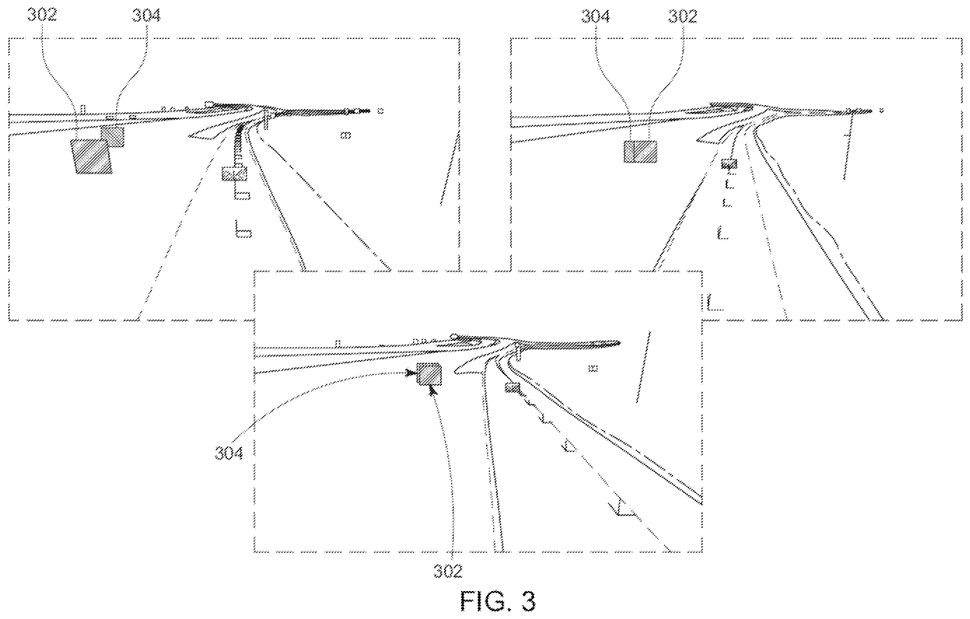

Because GPS or other position data may be somewhat inaccurate, the system may be configured to look at one or more existing features already mapped to refine the position information for the new object. Thus the system can be configured to search for existing map features along the trajectory. At operation 108 of example process 100, once an existing map feature is identified, the system may compare the determined vehicle-centric position of the existing map feature to a map-based position of the existing map feature (e.g., the position of the same object as indicated on the map). The results of this comparison may be used to determine a transformation (or function) that accurately aligns the positions and orientations of the vehicle along the trajectory and the vehicle-centric positions of the features with the map—the function/transformation computes their map-centric positions and orientations from their vehicle-centric positions and orientations. This may be based on a position offset, or difference, between the vehicle-centric position of the existing map feature and the map-based position of the existing map feature. In some applications, the transformation for a given object may be determined iteratively. An example of this iterative determination is shown and described with reference to FIG. 3, below.

As further shown in FIG. 1, operation 110 of example process 100 may apply the transformation calculated at operation 108 to the determined vehicle-centric position of the a feature to obtain a refined position of the feature in the map. For example, the system may apply the transformation calculated at operation 108 to the vehicle-centric position of the unmapped feature, or of a feature whose position, orientation or size has changed (based on vehicle data), to obtain a revised position of the feature. For example, the offset may identify a difference between the position of the object determined based on sensor data and the position of the object as specified by the map data indicating an error (in one, two or three dimensions) offset between the vehicle-centric and actual positions. Implementations may apply this determined position offset to the determined vehicle-centric position of the unmapped feature to obtain a refined position of the unmapped feature, as described above.

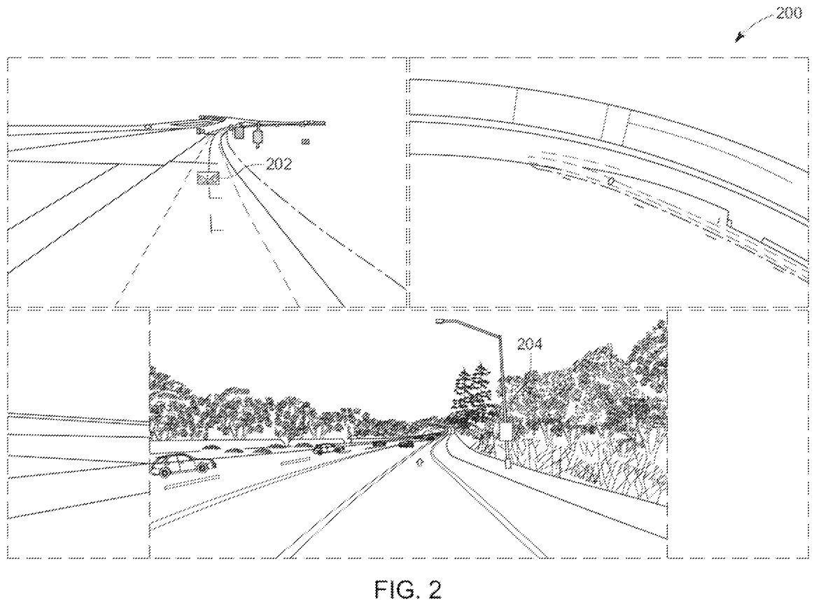

FIG. 2 illustrates an example dashboard 200 that may be presented to a system user. This example dashboard 200 includes three views. In other implementations other views may be provided. In this example, the top left is a view showing the beginning of the trajectory. Image icon 202 indicates a vehicle position. The upper right view is a top-down view of the trajectory with an indication of the vehicle on the trajectory. The bottom view shows the image from the vehicle's camera, which may be overlaid on top of the map (e.g., an HD or other resolution map). Transparency of the camera view can be adjusted to reveal features on the map. This can show, for example, how closely correlated the position of objects on the camera view or to their corresponding objects on the map.

In this example, we can assume that street sign 204 is a new feature that is unmapped—i.e., it is not included on the map. The system may be configured to detect this feature based on sensor data and identify it as being unmapped. For example, it might be identified as being unmapped because there is no corresponding feature that already exists in the map. A user viewing the example dashboard 200 may also make this determination. For example, the user might adjust the transparency of the camera image to see if a corresponding feature appears on the map. A user could also examine the map data to determine whether it exists.

As noted above with reference to FIG. 1, in some implementations, the system can be configured to scan sensor data from one or more of the vehicle sensors to identify existing map features along the vehicle trajectory. FIG. 3 illustrates an example of identifying existing map features. In this example, icon 302 represents an object as detected by one or more vehicle sensors. Representative icon 304 represents the same feature in the map data. As seen from the upper left example screenshot, the position of the object as determined based on vehicle sensor data (represented by icon 302) is different from the position of the object as identified in the map data (represented by icon 304). This offset may be due to any of a number of factors. For example, it may be assumed that the map data is correct, or at least more accurate than the information based on sensor data. By way of further example, position data determined using vehicle sensor data may be off due to errors/inaccuracies in the computation of the vehicles position, such as errors or inaccuracies in the vehicles GPS positioning system.

Accordingly, the system can calculate a transformation based on the offset between the object's position as determined by vehicle sensor data and the object's position as noted on the map data. The system can apply the transformation to correct information representing the position determined based on sensor data to partially or fully remove this offset. An example of the result of removing this offset is illustrated in the upper right hand screenshot where representative icons 302 and 304 are at least partially overlapping one another. In this example, however, there is still some position offset as the representative icons 302 and 304 are not fully overlapping. Accordingly, the offset determination and correction operations can be applied again to further an example of the result of this is shown in the example screenshot at bottom center. Here the position of the object as determined based on vehicle sensor data almost identically matches the position of the object as specified in the map data. Indeed, it can be seen that representative icon 302 (representing the object based on vehicle sensor data) almost perfectly overlaps with representative icon 304 (representing the position of the object as specified by the map data.

As described above with reference to operation 110, the position offset determined for the existing map feature can be applied to the sensor-based, or vehicle-centric, position of the new, unmapped feature to refine its position, with the intention of making this position data more accurate. In simplistic terms, the system can be configured to calculate the distance and direction (e.g., in three dimensions) that it “moved” the sensor-based object (represented by icon 304) and apply that same translation to the vehicle-centric position data of the new object with the intention of improving the accuracy of the position data for the new object.

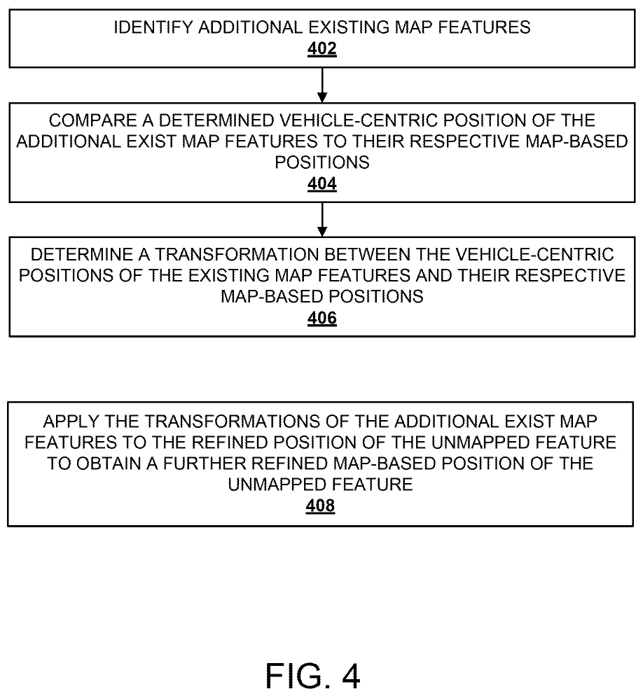

According to some aspects of the systems and methods described herein, the position information can be further refined by examining additional existing objects along the vehicle trajectory. FIG. 4 is a flowchart of an example process 400 for using additional existing objects to refine a new object's position data. At operation 402, the system may identify additional existing map features (i.e., objects along the trajectory that are already included in the map).

As also shown in FIG. 4, at operation 404 process 400 may include comparing the determined vehicle-centric position of the additional existing map features (based on sensor data gathered as the vehicle traversed the trajectory) to their respective map-based positions as identified in the map data. As further shown in FIG. 4, at operation 406 process 400 may include determining position offsets between the vehicle-centric positions of the existing map features and their respective map-based positions as identified in the map data. An example of comparing position data and determining offsets is illustrated in, and described above with reference to, FIG. 3.

At operation 408, the system may apply the position offsets determined for one or more of the additional existing map features to the refined position of the unmapped feature (e.g., as refined at operation 110 of FIG. 1) to obtain a further refined map-based position of the unmapped feature.

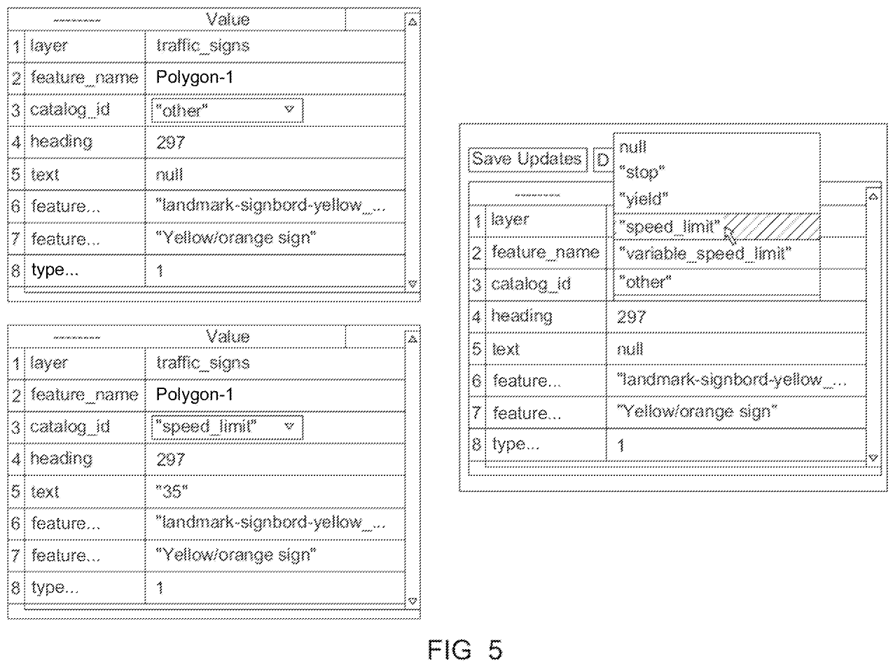

Aspects of the systems and methods may be implemented in which values for feature attributes of the new object may be identified and included with the map data for the new object. Values for these attributes may be determined automatically, such as by machine vision recognition of the object or they may be adjusted or input by the user. FIG. 5 illustrates an example of a user interface for updating attribute values for an object. In this example, the system was able to identify the object as a traffic sign based on sensor data, as shown by the designation in the layer attribute (attribute 1). The attribute heading (i.e., the direction it is facing) of 297 was also determined by the system based on sensor data as shown by attribute 4. The system was also able to use sensor data to determine the feature name (attribute 2), that the object is a landmark signboard (attribute 6), and that the object is a yellow/orange sign (attribute number seven).

Continuing with the screen shot in the upper left, the text attribute (attribute 5) as detected by the vehicle sensors, is “null” or nonexistent. In other words, the sensors were unable to detect sufficient information for the text attribute or image/character recognition was unable to determine the text based on the sensor data collected. Similarly, the system was unable to determine the catalog_id value (attribute 3). In this example the user uses the selection for attribute 3 (see example screenshots on the right hand side and lower left-hand side) to select “speed_limit” from the drop-down menu. Similarly, the user can type in the appropriate text attribute value, which in this case is “35”, representing that the speed limit posted on the sign is 35 mph. The user may reference the image from the camera to obtain these user-supplied attribute values.

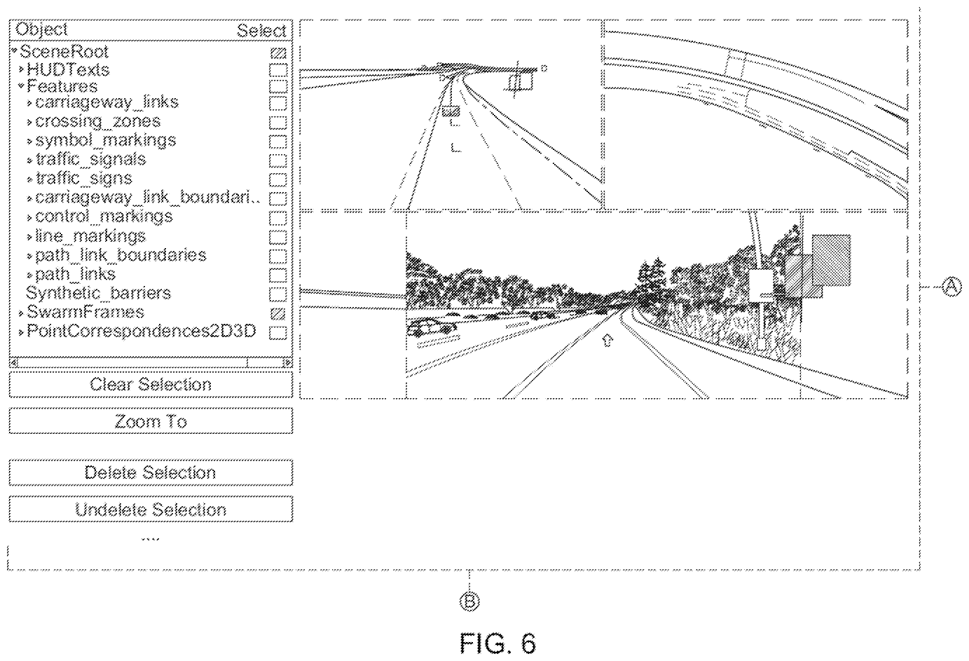

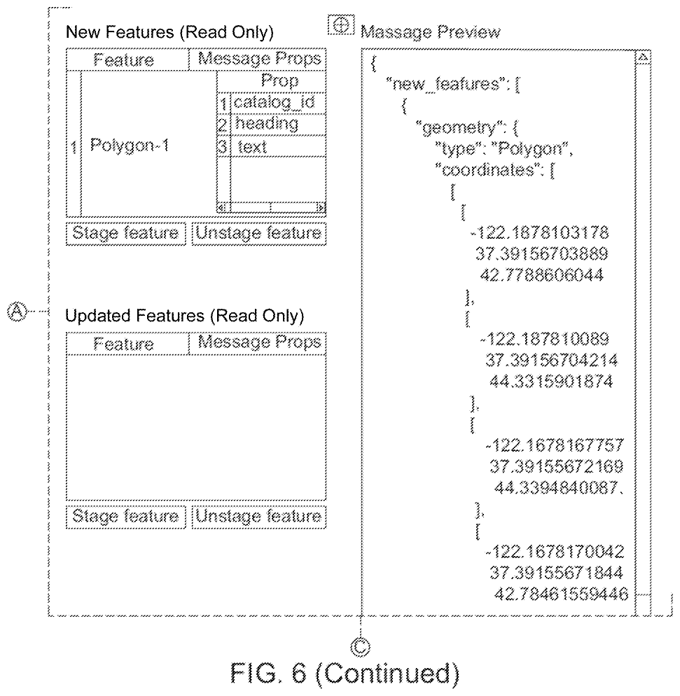

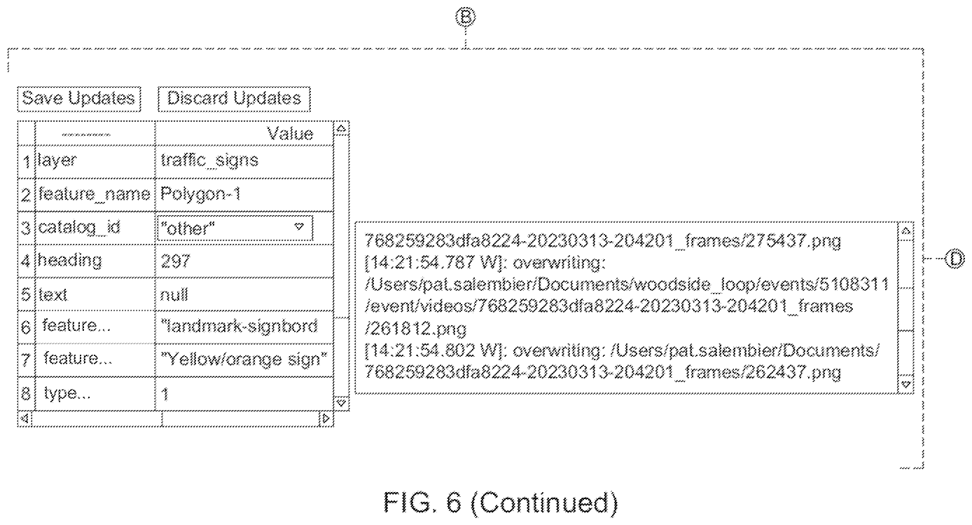

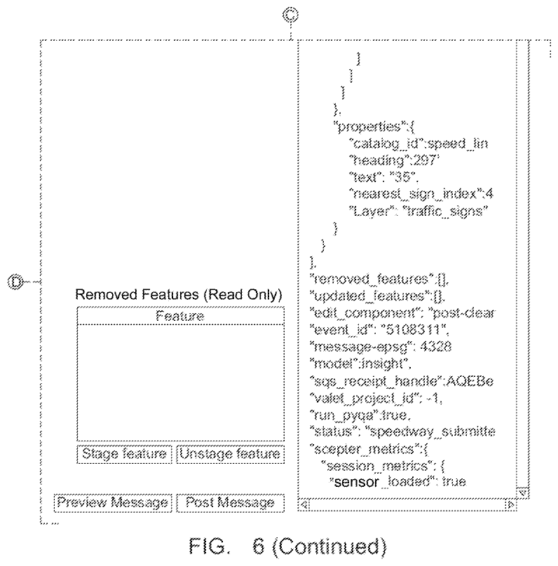

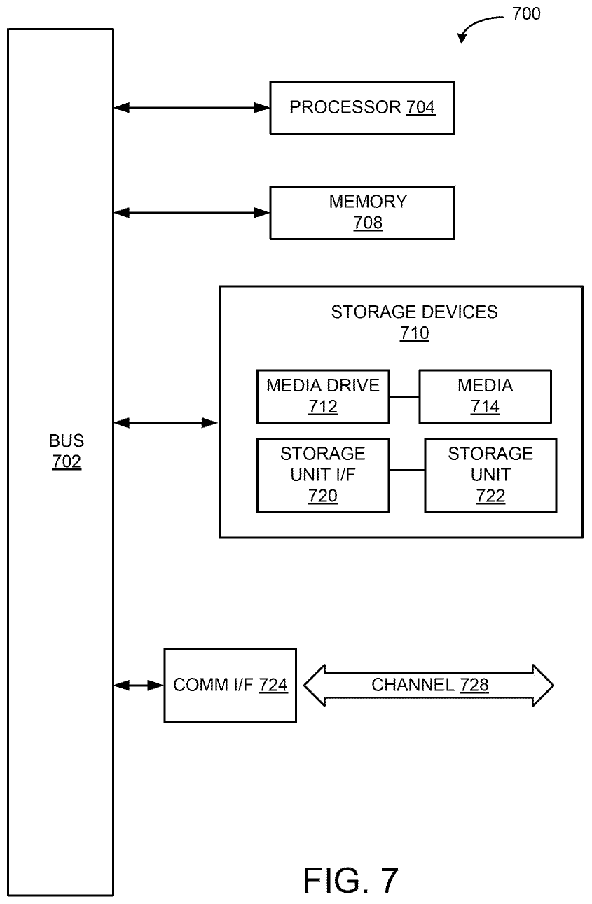

FIG. 6 illustrates an example of a more complete dashboard that includes not only the map and camera images, but also windows for entering/updating object parameters (e.g., attribute values), and for updating the object information to the map. As this example illustrates, the dashboard can be used to add new features, update features and remove features from the map. The dashboard can allow the user to advance through the trajectory to identify new features for addition to the map and existing features that can be used to refine the position of the new features.

Where the disclosed technology is implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as, for example, Ethernet, network interface card, IEEE 802.XX or other interface). Other examples include a communications port (such as, for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 722, storage media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for curating map data using sensor data collected from a vehicle along a trajectory of the vehicle, comprising:
detecting at least one change in a first feature at a determined position along the trajectory of the vehicle based on sensor data from one or more sensors of the vehicle;
scanning sensor data from the one or more sensors of the vehicle along the trajectory of the vehicle to identify sensor data representing one or more existing map features on a map;
determining a vehicle-centric position of the one or more existing map features based on the sensor data from one or more sensors of the vehicle;
comparing the determined vehicle-centric position of the one or more existing map features to a map-based position of their corresponding one or more existing map features and determining a difference between the vehicle-centric positions of the one or more existing map features and corresponding map-based positions of the one or more existing map features; and
determining a transformation based on the determined difference and applying the transformation to the vehicle-centric position of the first feature to obtain a revised position of the first feature.

2. The method of claim 1, wherein applying the transformation aligns positions of the vehicle along the trajectory and the vehicle-centric positions of the one or more existing features with the map.

3. The method of claim 2, wherein applying the transformation to the determined position of the first feature obtain a revised position of the first feature comprises applying the transformation to the determined vehicle-centric position of the first feature to obtain a revised position of the first feature in the map.

4. The method of claim 2, wherein applying the transformation to the vehicle-centric position of the first feature to obtain a revised position of the first feature comprises determining, based on sensor data, whether at least one of a position, orientation, or size of the first feature has changed, and upon detecting a change in at least one of a position, orientation, and size of the first feature, applying the transformation to the vehicle-centric position of the first feature to obtain at least one of a revised position, orientation, and size of the first feature.

5. The method of claim 4, further comprising updating at least one of the position, orientation and size of the first feature on the map to reflect the change.

6. The method of claim 1, wherein determining a transformation, comprises determining a position offset between the vehicle-centric position of the one or more existing map features and the map-based position of the one or more existing map features.

7. The method of claim 1, further comprising comparing the first feature to existing features on the map to determine if the first feature is a new feature.

8. The method of claim 7, further comprising updating the map to include the new feature at the revised position.

9. The method of claim 1, further comprising comparing a set of one or more vehicle-centric features to existing features on the map to determine if the first feature has been removed from along the trajectory and upon detection of removal of the feature, updating the map to reflect removal of the feature.

10. The method of claim 9, further comprising updating the map to remove the first feature from the map.

11. The method of claim 1, wherein the first feature comprises at least one of a road sign and lane markings.

12. A system for curating map data using sensor data collected from a vehicle along a trajectory of the vehicle comprising:
one or more processors configured to perform operations of:
detecting at least one change in a first feature at a determined position along the trajectory of the vehicle based on sensor data from one or more sensors of the vehicle;
scanning sensor data from the one or more sensors of the vehicle along the trajectory of the vehicle to identify sensor data representing one or more existing map features on a map;
determining a vehicle-centric position of the one or more existing map features based on the sensor data from one or more sensors of the vehicle;
comparing the determined vehicle-centric position of the one or more existing map features to a map-based position of their corresponding one or more existing map features and determining a difference between the vehicle-centric positions of the one or more existing map features and corresponding map-based positions of the one or more existing map features; and
determining a transformation based on the determined difference and applying the transformation to the vehicle-centric position of the first feature to obtain a revised position of the first feature.

13. The system of claim 12, wherein applying the transformation aligns positions of the vehicle along the trajectory and the vehicle-centric positions of the one or more existing map features with the map.

14. The system of claim 13, wherein applying the transformation to the determined position of the first feature obtain a revised position of the first feature comprises applying the transformation to the determined vehicle-centric position of the first feature to obtain a refined position of the first feature in the map.

15. The system of claim 13, wherein applying the transformation to the vehicle-centric position of the first feature to obtain a revised position of the first feature comprises determining, based on sensor data, whether at least one of a position, orientation, or size of the first feature has changed, and upon detecting a change in at least one of a position, orientation, and size of the first feature, applying the transformation to the vehicle-centric position of the first feature to obtain at least one of a revised position, orientation, and size of the first feature.

16. The system of claim 12, further comprising updating at least one of the position, orientation and size of the first feature on the map to reflect the change.

17. The system of claim 12, wherein determining a transformation, comprises determining a position offset between the vehicle-centric position of the one or more existing map features and the map-based position of the one or more existing map features.

18. The system of claim 12, wherein the one or more processors are further configured to perform the operation of comparing the first feature to existing features on the map to determine if the first feature is a new feature.

19. The system of claim 18, wherein the one or more processors are further configured to perform the operation of updating the map to include the new feature at the revised position.

20. The system of claim 12, wherein the one or more processors are further configured to perform the operation of comparing a set of one or more vehicle-centric features to existing features on the map to determine if the first feature has been removed from along the trajectory and upon detection of removal of the first feature, updating the map to reflect removal of the first feature.

21. The system of claim 20, wherein the one or more processors are further configured to perform the operation of updating the map to remove the first feature from the map.

22. The system of claim 12, wherein the first feature comprises at least one of a road sign and lane markings.
